(19) United States
(12) Patent Application Publication
(10) Pub. No.: US 2024/0402668 A1
(43) Pub. Date: Dec. 5, 2024

(54) BUILDING AI SMART MANAGEMENT SYSTEM

(71) Applicant: CHIEN-JONG CHANG, TAIPEI (TW)

(72) Inventor: CHIEN-JONG CHANG, TAIPEI (TW)

(21) Appl. No.: 18/327,155

(22) Filed: Jun. 1, 2023

(51) Int. Cl. G05B 19/042

(52) U.S. Cl. CPC G05B 19/042; G05B 2219/2642

(57) ABSTRACT

A building AI smart management system comprises a dashboard management module, a scheduling dashboard module, a statistics dashboard module, a data input report processing module, a data report output module, and a cross-platform link module, which are located on a server or a mobile device, wherein the server or the mobile device is electrically connected to the monitor.

### BACKGROUND OF THE INVENTION

### Field of the Invention

The invention relates to a system, and more particularly to a system for building AI smart management.

### The Prior Arts

In the property management work of the prior art, property events are managed separately through manual reports, and manual management and maintenance of equipment and meters of buildings are performed. It is not processed by the AI program. Unable to display the effect after integration. The property management work of the prior art is that the staff is small and the work is complicated, and the quality of the service often varies from person to person, and presents an unstable state.

### SUMMARY OF THE INVENTION

The invention provides a building AI smart management system, which comprises a dashboard management module located on a server, which comprises an organizational management performance index module, a facility management performance index module, both of which combine at least one measurement index with corresponding evaluation methods, and calculate a score based on the execution results, which is displayed on a monitor; and a cloud smart device monitoring module connected to at least one sensor disposed within a building, which transmits at least one monitoring signal to the cloud smart device monitoring module and displays the monitoring signal on the monitor, wherein the organizational management performance index module, the facility management performance index module, and the cloud smart device monitoring module are respectively electrically connected to the monitor.

The building AI smart management system of the invention may further comprise a scheduling dashboard module located on the server, which allows various schedules within the building's annual management plan to be input through at least one scheduling log, so that an AI program is capable of determining the status of the at least one scheduling log, and displaying a warning on the monitor accordingly, wherein the status of the at least one scheduling log to be determined is whether a schedule is approaching its deadline, or whether a schedule has passed without being executed.

The building AI smart management system of the invention may further comprise a statistics dashboard module located on the server, which displays the statistical frequency of various service events within the building on the monitor, including at least one of: the number of public area maintenance items, counseling orders, social work visits, caring meal deliveries, emergency rescues, property management cares, community visits, and package mail receipts and deliveries.

The building AI smart management system of the invention may further comprise a data input report processing module located on the server, which processes AI smart management information, including a first digital data transmitted by the sensor and a first data generated by the server input, wherein the scope of the first data is clearly defined by manual pre-setting, and is entered daily into at least one database in Google Forms, and the AI program performs statistical analysis, status determination, string search, and corresponding AI domain applications on the at least one database.

The building AI smart management system of the invention may further comprise a data report output module located on the server, which creates a daily log database of the building's on-site management; wherein the AI program uses the string search function to search for keywords in the daily log database, collects the necessary data, and performs related statistical and regression analysis; and a cross-platform link module located on the server, which is a cross-platform AI smart management interface that automatically connects at least one management tool module to manage the data generated by the management tool module.

The invention further provides a building AI smart management system, which comprises a dashboard management module located on a mobile device, which comprises an organizational management performance index module, a facility management performance index module, both of which combine at least one measurement index with corresponding evaluation methods, and calculate a score based on the execution results, which is displayed on a monitor; and a cloud smart device monitoring module connected to at least one sensor disposed within a building, which transmits at least one monitoring signal to the cloud smart device monitoring module and displays the monitoring signal on the monitor, wherein the organizational management performance index module, the facility management performance index module, and the cloud smart device monitoring module are respectively electrically connected to the monitor.

The building AI smart management system of the invention may further comprises a scheduling dashboard module located on the mobile device, which allows various schedules within the building's annual management plan to be input through at least one scheduling log, so that an AI program is capable of determining the status of the at least one scheduling log, and displaying a warning on the monitor accordingly, wherein the status of the at least one scheduling log to be determined is whether a schedule is approaching its deadline, or whether a schedule has passed without being executed.

The building AI smart management system of the invention may further comprise a statistics dashboard module located on the mobile device, which displays the statistical frequency of various service events within the building on the monitor, including at least one of: the number of public area maintenance items, counseling orders, social work visits, caring meal deliveries, emergency rescues, property management cares, community visits, and package mail receipts and deliveries.

The building AI smart management system of the invention may further comprise a data input report processing module located on the mobile device, which processes AI smart management information, including a first digital data transmitted by the sensor and a first data generated by the server input, wherein the scope of the first data is clearly defined by manual pre-setting, and is entered daily into at least one database in Google Forms, and the AI program performs statistical analysis, status determination, string search, and corresponding AI domain applications on the at least one database.

The building AI smart management system of the invention may further comprise a data report output module located on the mobile device, which creates a daily log database of the building's on-site management; wherein the AI program uses the string search function to search for keywords in the daily log database, collects the necessary data, and performs related statistical and regression analysis; and a cross-platform link module located on the server, which is a cross-platform AI smart management interface that automatically connects at least one management tool module to manage the data generated by the management tool module.

### BRIEF DESCRIPTION OF THE DRAWINGS

The invention will become more readily apparent to those ordinarily skilled in the art after reviewing the following detailed description and accompanying drawings, in which:

FIG. 1 is a schematic diagram of modules of a server of the building AI smart management system of the present invention.

FIG. 2 is a schematic diagram of modules of a mobile device in the building AI smart management system of the present invention.

FIG. 3 is a schematic diagram of the organizational management performance index module of the dashboard management module of the present invention.

FIG. 4 is a schematic diagram of the facility management performance index module of the dashboard management module of the present invention.

FIG. 5A is a schematic diagram of the cloud smart device monitoring module of the dashboard management module of the present invention.

FIG. 5B is a schematic diagram of the digital signal sent back by the sensor of the present invention including the standby status, voltage value, current value, and power value of the sewage pump or wastewater pump.

FIG. 5C is a schematic diagram of the digital signal sent back by the sensor of the present invention including the current depth of the sewage pool and the wastewater pool in Building A.

FIG. 5D is a schematic diagram of the digital signal sent back by the sensor of the present invention including the current, voltage, and power detected by the water pump, sewage pump, and wastewater pump of Building B, as well as the depth of the water pumping pool and the depth of the sewage pool.

### DETAILED DESCRIPTION OF PREFERRED EMBODIMENTS

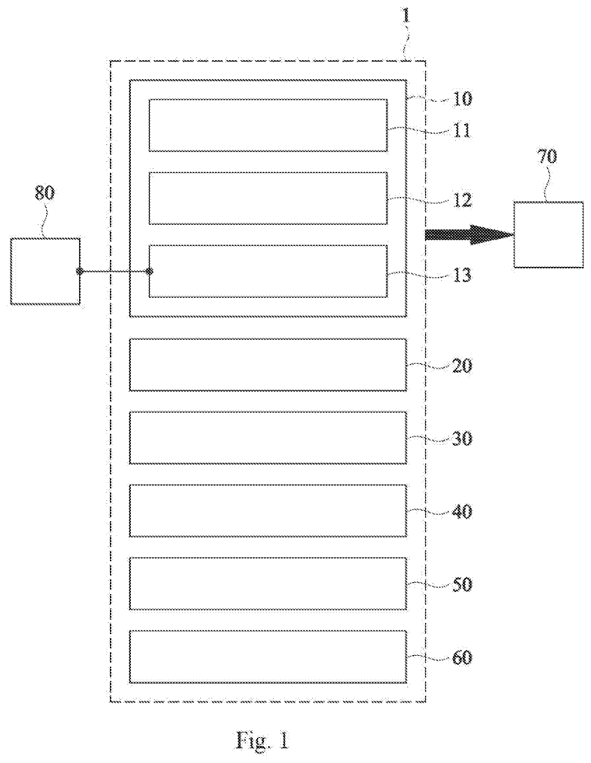

As shown in FIG. 1, the present invention is a building AI smart management system, a schematic diagram of a module in a server 1. It has a dashboard management module 10, a scheduling dashboard module 20, a statistics dashboard module 30, a data input report processing module 40, a data report output module 50, and a cross-platform link module 60 located in the server 1, wherein the server 1 is connected to a monitor 70.

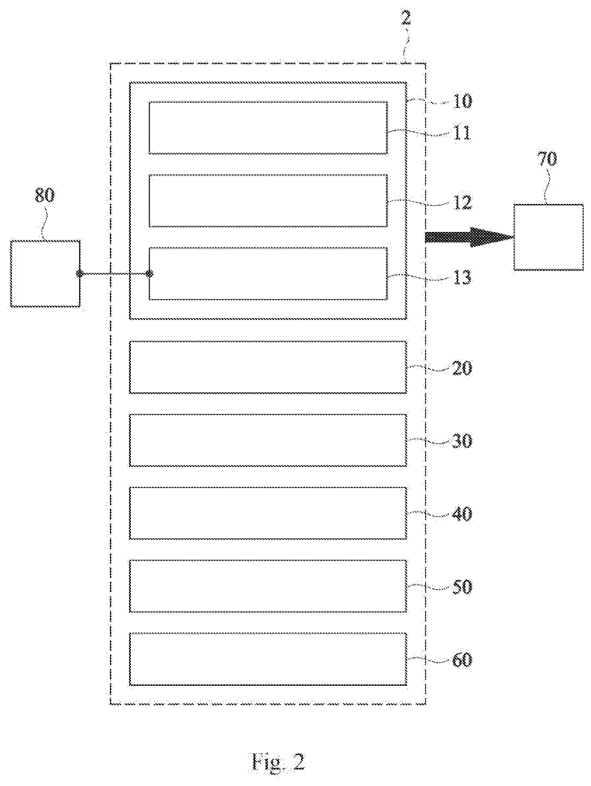

As shown in FIG. 2, the present invention is a building AI smart management system, a schematic diagram of a module on a mobile device 2. It has a dashboard management module 10, a scheduling dashboard module 20, a statistics dashboard module 30, a data input report processing module 40, a data report output module 50, and a cross-platform link module 60 located in the server 1, wherein the server 1 is connected to a monitor 70.

As shown in FIG. 1, the present invention is a building AI smart management system, which comprises: a building AI smart management system, including: a dashboard management module 10 located in a server 1, the dashboard management module 10 has an organizational management performance index module 11 and a facility management performance index module 12, where at least one measurement index is combined with the corresponding evaluation method to make a scoring result based on the number of execution results, and the scoring result displayed on a monitor 70, and a cloud smart device monitoring module 13, connected to at least one sensor of construction equipment in a building, the sensor returns at least one monitoring signal to the cloud smart device monitoring module 13, and the Monitoring signals are displayed on the monitor 70.

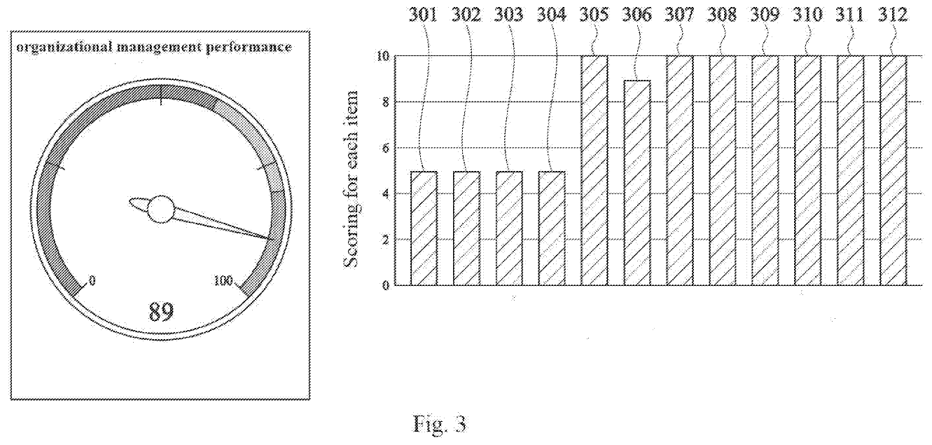

As shown in FIG. 3, the present invention is an AI intelligent management system for buildings, in which the organizational management performance index module 11 uses preset indicators to evaluate the actual score to represent the actual execution performance and evaluation content, such as Table 1:

TABLE 1

| | | Evaluation | Execution | | | |
|---|---|---|---|---|---|---|
| Item | Metrics | method | Scenario | Scoring | Scored | Remarks |
| 1 | Number of | Count | Occupational | 10 | | 0 occurrence |
| | Occupational | Occupational | Accident | | | get 10 |
| | Accidents | Accident | Occurrence ○ | | | points, one |
| | | Occurrence | | | | occurrence |
| 2 | Number of | Statistics of | Occurrence of | 10 | | deducts 2 |
| | cases of | business | business | | | points, and |
| | business | misappropriation | misappropriation | | | the |
| | misappropriation | cases | ○ cases | | | maximum |
| 3 | Number of | Count the | Occurrence of | 10 | | 10 points. |
| | labor-management | number of | labor-management | | | |
| | disputes | labor-management | disputes ○ | | | |
| | | disputes | | | | |
| 4 | Number of | Statistics of | Occurrence of | 10 | | |
| | violations of the | the number of | violations of the | | | |
| | Gender Equality | violations of | Gender Equality | | | |
| | Act | the Gender | Act ○ | | | |
| | | Equality Act | | | | |
| 5 | Number of | Statistics of | Occurrences of | 10 | | |
| | Abnormal | the Number of | Abnormal | | | |
| | Absences Count | Abnormal | Absences ○ | | | |
| | | Absences | | | | |
| 6 | On-site | Total | ○ points/○ | 10 | | 10 points for |
| | employee | score/number | copies of | | | average |
| | satisfaction | of statistically | statistically | | | satisfaction |
| | survey | returned | returned | | | above 90, 9 |
| | | questionnaires | questionnaires = | | | for 89~85 |
| | | average | average | | | 84~80 points, |
| | | satisfaction | satisfaction | | | 8 points, and |
| | | Total | | | | so on. |
| 7 | Acquisition rate | protection | Licenses | 10 | | 0 points for |
| | of property | Affairs | obtained ○ | | | not reached |
| | management | management | pieces/staff | | | 1, 5 points |
| | professional | personnel, fire | and on-site | | | for 1, 8 |
| | certificates | facility | supervisors ○ | | | points for 2, |
| | | managers, | | | | 10 points for |
| | | equipment | | | | 3 |
| | | safety | | | | |
| | | management | | | | |
| | | personnel | | | | |
| | | (number of | | | | |
| | | licenses | | | | |
| | | obtained/total | | | | |
| | | number of | | | | |
| | | staff and | | | | |
| | | on-site | | | | |
| | | supervisors) | | | | |
| 8 | Average years | Total years of | Total ○ years of | 10 | | 0 points for |
| | of on-site | on-site | on-site | | | less than 1 |
| | supervisors | supervisors/ | supervisors/On- | | | year, 5 points |
| | | Number of | site supervisors | | | for 1-3 years, |
| | | on-site | ○ | | | 8 points for |
| | | supervisors | | | | 3-5 years, 10 |
| | | | | | | points for |
| | | | | | | more than 5 |
| | | | | | | years |
| 9 | Year resignation | The number of | the resigned ○ | 10 | | Calculated in |
| | rate | resigned | people in the | | | proportion |
| | | employees in | whole year/ | | | |
| | | the whole | [the ○ people at | | | |
| | | year/ | the beginning of | | | |
| | | [the number at | the period + ½ | | | |
| | | the beginning | (the new | | | |
| | | of the period + | entrants in the | | | |
| | | ½ (the | whole year)] | | | |
| | | number of new | | | | |
| | | entrants in the | | | | |
| | | whole year)] | | | | |
| 10 | Retention rate | 1. On-site | number of | 5 | | |
| | of on-site | supervisor | people with | | | |
| | personnel | (number of | seniority of | | | |
| | | people with | more than 6 | | | |
| | | seniority of | months in the | | | |
| | | more than 6 | number of | | | |
| | | months in the | people at the | | | |
| | | number of | end of the | | | |
| | | people at the | period ○/ | | | |
| | | end of the | number of | | | |
| | | period/number | people in 6 | | | |
| | | of people with | months ago ○ | | | |
| | | seniority of | | | | |
| | | more than 6 | | | | |
| | | months in the | | | | |
| | | beginning of | | | | |
| | | the period) | | | | |
| | | 2. On-site | the number of | 5 | | |
| | | administrative | people with | | | |
| | | personnel (the | seniority of | | | |
| | | number of | more than 6 | | | |
| | | people with | months in the | | | |
| | | seniority of | number of | | | |
| | | more than 6 | people at the | | | |
| | | months in the | end of the | | | |
| | | number of | period ○/the | | | |
| | | people at the | number of | | | |
| | | end of the | people 6 months | | | |
| | | period/ | ago ○ | | | |
| | | number of | | | | |
| | | people in 6 | | | | |
| | | months ago) | | | | |

Total Score

Wherein, as shown in FIG. 3, Items represent as Number of Occupational Accidents 301, Number of cases of business misappropriation 302, Number of labor-management disputes 303, Number of violations of the Gender Equality Act 304, Number of Abnormal Absences Count 305, On-site employee satisfaction survey 306, Acquisition rate of property management professional certificates 307, Average years of on-site supervisors 308, Year resignation rate 309, Retention rate of on-site personnel 310.

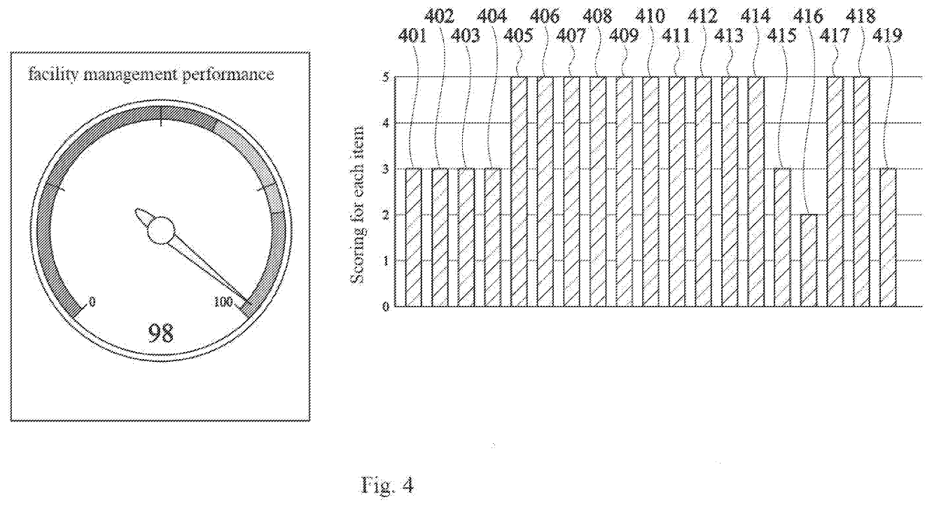

As shown in FIG. 4, the present invention is an AI intelligent management system for buildings, wherein the facility management performance index module 12 uses preset indicators to evaluate the actual score to represent the actual execution performance and evaluation content, such as Table 2:

TABLE 2

| | Measuring | Evaluation | Execution | | | |
|---|---|---|---|---|---|---|
| Item | Index | Method | Description | Scoring | Scored | Remarks |
| 1 | Qualification | 1. Number of | On-site | 4 | | |
| | rate of stationed | on-site | supervisors ○ | | | |
| | personnel | supervisors, | persons, | | | |
| | | administrative | administrative | | | |
| | | personnel, and | personnel ○ | | | |
| | | cleaning | persons, | | | |
| | | personnel/ | cleaning | | | |
| | | number | personnel ○ | | | |
| | | required by | persons/contract | | | |
| | | the contract | requirements | | | |
| | | | ○ persons | | | |
| | | 2. Number of | Security | 4 | | |
| | | security | personnel ○ | | | |
| | | personnel/ | persons/Contract | | | |
| | | Number of | requirements | | | |
| | | contract | ○ persons | | | |
| | | requirements | | | | |
| 2 | Correct | 1. Number of | Registered ○ | 4 | | |
| | implementation | registered | pieces/Delivered | | | |
| | rate of | mails/Number | by the post | | | |
| | community | of mails | office ○ pieces | | | |
| | registered | delivered by | | | | |
| | letters | the post office | | | | |
| | | 2. Number of | pieces | 3 | | 3 points |
| | | lost pieces/ | lost/number of | | | are |
| | | number of | pieces | | | awarded |
| | | pieces | delivered by | | | for none, |
| | | delivered by | the post office | | | and 3 |
| | | the post office | ○ pieces | | | points are |
| | | ○ | | | | deducted |
| | | | | | | for one |
| | | | | | | time. |
| 3 | Tenant | Total | Total ○ | 5 | | |
| | Survey | scores/copies | points/○ copies | | | |
| | Satisfaction | of statistically | of statistically | | | |
| | | returned | returned | | | |
| | | questionnaires = | questionnaires = | | | |
| | | average | average | | | |
| | | satisfaction | satisfaction | | | |
| 4 | Social housing | Number of | Applicants ○/ | 4 | | |
| | service cloud | applicants/ | total tenants ○ | | | |
| | application rate | total number | | | | |
| | | of tenants | | | | |
| 5 | Registration of | construction | establishment | 4 | | |
| | public property | of property | of ○ | | | |
| | | inventory | households/ | | | |
| | | (number of | total number of | | | |
| | | established | households ○) | | | |
| | | households/ | | | | |
| | | total number | | | | |
| | | of households) | | | | |
| 6 | The punctuality | The | Whether the | 4 | | |
| | of pre-planning | punctuality of | monthly data is | | | |
| | and | monthly data | delivered on | | | |
| | performance | delivery | time or not | | | |
| | data | | yes/no | | | |
| 7 | Achievement | 1. Elevator | Elevator | 4 | | |
| | rate of | maintenance | maintenance ○ | | | |
| | scheduled | times/annual | times/annual | | | |
| | maintenance of | scheduled | scheduled | | | |
| | public facilities | maintenance | maintenance ○ | | | |
| | and equipment | times | times | | | |
| | | 2. Generator | Generator | 4 | | |
| | | maintenance | maintenance ○ | | | |
| | | times/annual | times/annual | | | |
| | | scheduled | scheduled | | | |
| | | maintenance | maintenance ○ | | | |
| | | times | times | | | |
| 8 | Qualification | 1. Elevator use | The effective | 4 | | |
| | rate of public | license | date of the | | | |
| | facilities and | | elevator use | | | |
| | equipment | | license: | | | |
| | inspection and | | (dd/mm) | | | |
| | filing | 2. Pass the fire | Yes/No | 4 | | |
| | | inspection | pass the fire | | | |
| | | report | inspection | | | |
| | | | report | | | |
| | | 3. Public | Public safety | 4 | | |
| | | security | inspection | | | |
| | | inspection | declaration | | | |
| | | declaration is | is/is not | | | |
| | | qualified | qualified | | | |
| 9 | Evaluating the | electricity | public | 3 | | 3 points |
| | effectiveness of | Last year's | Total last | | | for |
| | energy conservation | public | year's large | | | positive |
| | | kwh-this | public | | | numbers |
| | | year's public | electricity | | | and 0 |
| | | electricity kwh | ○ kwh-this | | | points for |
| | | | year's large | | | negative |
| | | | electricity kwh | | | numbers. |
| | | | | | | More than |
| | | | | | | 20% |
| | | | | | | (now-go/go) |
| | | | | | | should |
| | | | | | | write a |
| | | | | | | review |
| | | | | | | report. |
| 10 | Drinking water | Inspection and | Inspection and | 3 | | |
| | tower water | test report | test report is/is | | | |
| | quality test | meets the | not in line with | | | |
| | | standard value | the standard | | | |
| 11 | Achievement | Pool cleaning | Pool cleaning | 3 | | |
| | rate of cleaning | times/annual | ○ times/annual | | | |
| | and | scheduled | scheduled ○ times | | | |
| | maintenance | times | | | | |
| | operations | | | | | |
| 12 | Achievement | Implementation | Implementation ○ | 3 | | |
| | rate of vector | times/annual | times/annual | | | |
| | control | scheduled | scheduled ○ times | | | |
| | | times | | | | |
| 13 | Incidence rate | 1. Count the | Occurrence ○ | 3 | | 3 points |
| | of theft | number of | | | | for none, 3 |
| | | occurrences | | | | points for |
| | | | | | | one time. |
| | | 2. Abnormal | Abnormal | | | Each |
| | | analysis report | analysis report | | | report +2 |
| | | after the theft | after the theft | | | |
| | | 3. Specific | Specific | | | Each |
| | | improvement | improvement | | | report +2 |
| | | measures | measures | | | |
| 14 | Fire accident | 1. Count the | Occurrence ○ | 4 | | 4 points |
| | rate | number of | | | | for none, 4 |
| | | incidents | | | | points for |
| | | | | | | one time. |
| | | 2. Abnormality | Abnormality | 2 | | No |
| | | analysis report | analysis report | | | report-2 |
| | | after fire | after fire | | | |
| | | accident | accident | | | |
| | | 3. Specific | Specific | 2 | | No |
| | | improvement | improvement | | | specific |
| | | measures | measures | | | improvement-2 |
| 15 | Fire prevention | Drill | Drill ○ | 3 | | |
| | and escape drill | times/annual | times/annual | | | |
| | rate | scheduled | scheduled ○ | | | |
| | | times | times | | | |
| 16 | Occurrence rate | 1. Check the | Yes/No | 5 | | |
| | of other | emergency | Emergency | | | |
| | emergencies | handling | handling | | | |
| | (such as: | process | process table | | | |
| | typhoon, | 2. Count the | Count the | 3 | | 3 points |
| | earthquake, | number of | occurrence | | | are |
| | elevator failure, | occurrences | of ○times | | | awarded |
| | power failure, | | | | | for none, |
| | gas leakage) | | | | | and 3 |
| | | | | | | points are |
| | | | | | | deducted |
| | | | | | | for one |
| | | | | | | time. |
| | | 3. Abnormal | Abnormal | | | +2 for |
| | | analysis report | analysis report | | | each report |
| | | after | after | | | |
| | | emergency | emergency | | | |
| | | accident | accident | | | |
| | | 4. Specific | Specific | | | Each |
| | | improvement | improvement | | | report +1 |
| | | measures | measures | | | |
| 17 | Agency | Five | Whether it | 5 | | 5 points if |
| | Requirements | categories of | meets the | | | there is no |
| | | service work | requirements | | | missing, 1 |
| | | results | of work items | | | point will |
| | | | | | | be |
| | | | | | | deducted |
| | | | | | | for one |
| | | | | | | item |
| | | Cooperate | Delay ○ times | 3 | | No |
| | | with contract | | | | missing 3 |
| | | performance | | | | points, 1 |
| | | and submit | | | | point |
| | | materials on | | | | deduction |
| | | time | | | | for 1 delay |
| 18 | Good | Cooperate | Number of | | In addition | |
| | neighborliness | with | times | | to the | |
| | | government | | | activities | |
| | | agencies and | | | stipulated | |
| | | neighborhood | | | by the | |
| | | communities | | | agency, 1 | |
| | | to handle | | | point is | |
| | | activities | | | awarded for | |
| | | | | | each | |
| | | | | | additional | |
| | | | | | activity | |
| | | | | | hosted | |
| 19 | The public | 1. Major | Number of | 3 | | 3 points |
| | complains | defects | occurrences | | | for none, 1 |
| | about the | | | | | point |
| | manufacturer's | | | | | deducted |
| | service quality | | | | | for one |
| | | | | | | time. |
| | | 2. Occurrence | Occurrence | 3 | | 3 points |
| | | frequency | frequency | | | for none, |
| | | | | | | once a |
| | | | | | | month on |
| | | | | | | average, 1 |
| | | | | | | point will |
| | | | | | | be |
| | | | | | | deducted; |
| | | | | | | 2 times a |
| | | | | | | month on |
| | | | | | | average, 2 |
| | | | | | | points will |
| | | | | | | be |
| | | | | | | deducted, |
| | | | | | | and so on |
| | | 3. Specific | Specific | | | 1 point for |
| | | improvement | improvement | | | each item |
| | | measures | measures | | | |

Total Score

Wherein, as shown in FIG. 4, Items represent as Qualification rate of stationed personnel 401, Correct implementation rate of community registered letters 402, Tenant Satisfaction Survey 403, Social housing service cloud application rate 404, Registration of public property 405, The punctuality of pre-planning and performance data 406, Achievement rate of scheduled maintenance of public facilities and equipment 407, Qualification rate of public facilities and equipment inspection and filing 408, Evaluating the effectiveness of energy conservation 409, Drinking water tower water quality test 410, Achievement rate of cleaning and maintenance operations 411, Achievement rate of vector control 412, Incidence rate of theft 413, Fire accident rate 414, Fire prevention and escape drill rate 415, Occurrence rate of other emergencies (such as: typhoon, earthquake, elevator failure, power failure, gas leakage) 416, Agency Requirements 417, Good neighborliness 418, The public complains about the manufacturer's service quality 419.

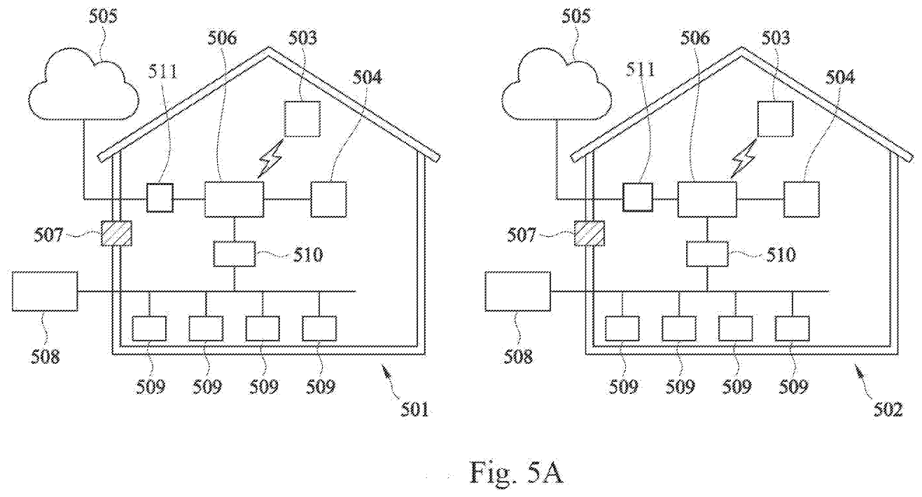

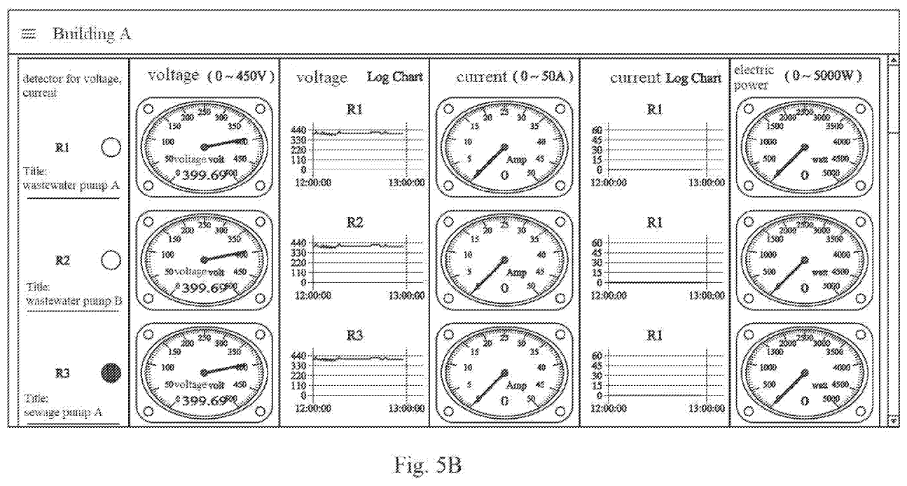

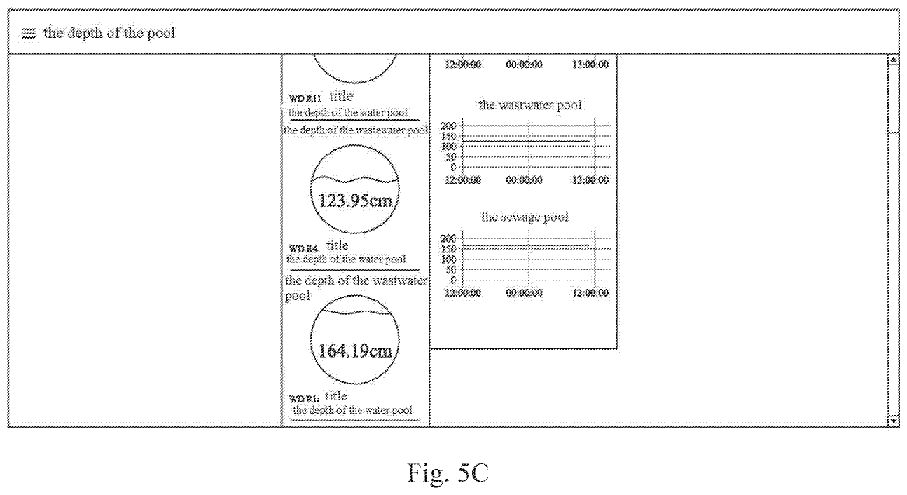

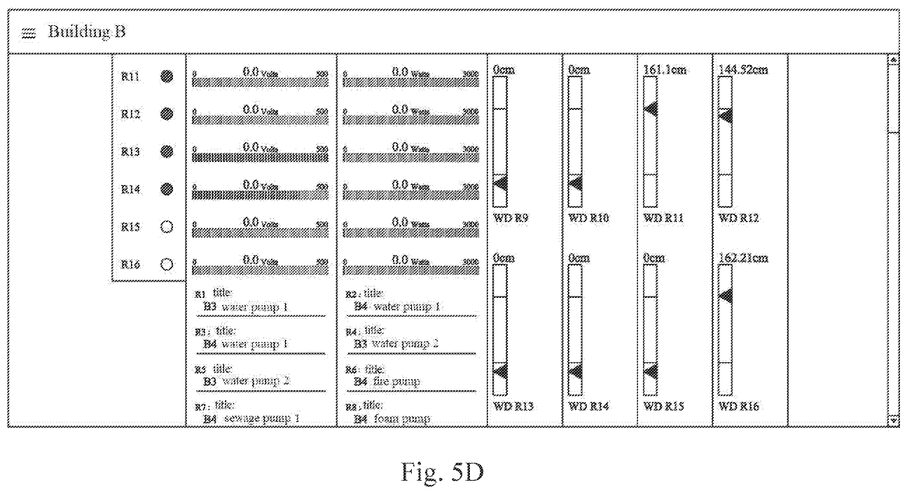

As shown in FIG. 5A, the present invention is an AI intelligent management system for buildings, in which the cloud smart device monitoring module 13 can be connected to the digital signal sent back by the sensor to judge the operation status of the field equipment. As shown in FIG. 5B, for example, the standby status, voltage value, current value, and power value of a sewage pump or wastewater pump in a building. As shown in FIG. 5C, the current depths of the sewage pond and wastewater pond in building A. As shown in FIG. 5D, detected current, voltage, and electric power of the water pumps, sewage pumps, and wastewater pumps in building B. And the depth of the pumping pool and the depth of the sewage pool. As shown in FIG. 5A, Building A 501, Building B 502, WIFI CAMERA 503, LAN CAMERA 504, internet 505, WAN ROUTER 506, intercom 507, Public Switched Telephone Network, PSTN 508, TELEHPON 509, Exchange interface 510, FIBER-OPTIC COMMUNICATION 511.

The present invention is an AI intelligent management system for buildings further comprises a scheduling dashboard module 20, located in the server 1 or the mobile device 2, wherein various schedules in the building site management annual plan are input into the scheduling dashboard module 20 through at least one schedule log, and at least one status of the schedule log can be judged through an AI program, the schedule that is about to expire, or the schedule that is overdue execution of the schedule raises an alert on the monitor 70.

The AI intelligent management system for buildings of the present invention further comprises a statistics dashboard module 30 located on the server 1 or the mobile device 2, wherein the statistics dashboard module 30 displays the statistical frequency of various service events within the building on the monitor 70, including at least one of: the number of public area maintenance items, counseling orders, social work visits, caring meal deliveries, emergency rescues, property management cares, community visits, and package mail receipts and deliveries.

The building AI smart management system of the present invention further comprises a data input report processing module 40, which is located in the server 1 or the mobile device 2, wherein the data input report processing module 40 processes an AI smart management information, including: a first digital data, which is the digital data transmitted by the sensor 80, and a first data, which is the data generated by the input of the server 1, the first data generated by the input of the server 1, wherein the scope of the first data is clearly defined by manual pre-setting, and at least one database is formed by inputting a Google form every day, and the AI program is used to perform statistical analysis of the at least one database, judgment or determination of the status of the at least one database, string search of the at least one database, and corresponding AI domain application.

The building AI smart management system of the present invention further comprises a data report output module 50, located in the server 1 or the mobile device 2, the building A log database is formed from the work logs of the on-site management. Through the word string search function of the AI program, the keywords of the log database are searched, the required data are collected, and relevant statistical analysis and regression analysis are performed.

The building AI smart management system of the present invention further comprises a cross-platform link module 60, located in the server 1 or the mobile device 2, which is a cross-platform AI smart management interface. The platform is connected to at least one management tool module through management automation, so as to manage the data generated by the at least one management tool module.

The above descriptions and descriptions are only descriptions of the preferred embodiments of the present invention. Those who have common knowledge of this technology may make other modifications according to the scope of the patent application defined below and the above descriptions, but these modifications should still be It is for the creative spirit of the present invention and within the scope of rights of the present invention.

What is claimed is:

1. A building AI smart management system, comprising:
a dashboard management module located on a server, which comprises an organizational management performance index module, a facility management performance index module, both of which combine at least one measurement index with corresponding evaluation methods, and calculate a score based on the execution results, which is displayed on a monitor; and a cloud smart device monitoring module connected to at least one sensor disposed within a building, which transmits at least one monitoring signal to the cloud smart device monitoring module and displays the monitoring signal on the monitor, wherein
the organizational management performance index module, the facility management performance index module, and the cloud smart device monitoring module are respectively electrically connected to the monitor.

2. The building AI smart management system according to claim 1, further comprising:
a scheduling dashboard module located on the server, which allows various schedules within the building's annual management plan to be input through at least one scheduling log, so that an AI program is capable of determining the status of the at least one scheduling log, and displaying a warning on the monitor accordingly, wherein the status of the at least one scheduling log to be determined is whether a schedule is approaching its deadline, or whether a schedule has passed without being executed.

3. The building AI smart management system according to claim 2, further comprising:
a statistics dashboard module located on the server, which displays the statistical frequency of various service events within the building on the monitor, including at least one of: the number of public area maintenance items, counseling orders, social work visits, caring meal deliveries, emergency rescues, property management cares, community visits, and package mail receipts and deliveries.

4. The building AI smart management system according to claim 3, further comprising:
a data input report processing module located on the server, which processes AI smart management information, including a first digital data transmitted by the sensor and a first data generated by the server input, wherein the scope of the first data is clearly defined by manual pre-setting, and is entered daily into at least one database in Google Forms, and the AI program performs statistical analysis, status determination, string search, and corresponding AI domain applications on the at least one database.

5. The building AI smart management system according to claim 4, further comprising:
a data report output module located on the server, which creates a daily log database of the building's on-site management; wherein the AI program uses the string search function to search for keywords in the daily log database, collects the necessary data, and performs related statistical and regression analysis; and
a cross-platform link module located on the server, which is a cross-platform AI smart management interface that automatically connects at least one management tool module to manage the data generated by the management tool module.

6. A building AI smart management system, comprising:
a dashboard management module located on a mobile device, which comprises an organizational management performance index module, a facility management performance index module, both of which combine at least one measurement index with corresponding evaluation methods, and calculate a score based on the execution results, which is displayed on a monitor; and a cloud smart device monitoring module connected to at least one sensor disposed within a building, which transmits at least one monitoring signal to the cloud smart device monitoring module and displays the monitoring signal on the monitor, wherein
the organizational management performance index module, the facility management performance index module, and the cloud smart device monitoring module are respectively electrically connected to the monitor.

7. The building AI smart management system according to claim 6, further comprising:
a scheduling dashboard module located on the mobile device, which allows various schedules within the building's annual management plan to be input through at least one scheduling log, so that an AI program is capable of determining the status of the at least one scheduling log, and displaying a warning on the monitor accordingly, wherein the status of the at least one scheduling log to be determined is whether a schedule is approaching its deadline, or whether a schedule has passed without being executed.

8. The building AI smart management system according to claim 7, further comprising:
a statistics dashboard module located on the mobile device, which displays the statistical frequency of various service events within the building on the monitor, including at least one of: the number of public area maintenance items, counseling orders, social work visits, caring meal deliveries, emergency rescues, property management cares, community visits, and package mail receipts and deliveries.

9. The building AI smart management system according to claim 8, further comprising:
a data input report processing module located on the mobile device, which processes AI smart management information, including a first digital data transmitted by the sensor and a first data generated by the server input, wherein the scope of the first data is clearly defined by manual pre-setting, and is entered daily into at least one database in Google Forms, and the AI program performs statistical analysis, status determination, string search, and corresponding AI domain applications on the at least one database.

10. The building AI smart management system according to claim 9, further comprising:
a data report output module located on the mobile device, which creates a daily log database of the building's on-site management; wherein the AI program uses the string search function to search for keywords in the daily log database, collects the necessary data, and performs related statistical and regression analysis; and
a cross-platform link module located on the server, which is a cross-platform AI smart management interface that automatically connects at least one management tool module to manage the data generated by the management tool module.
